(19) United States
(12) Patent Application Publication
(10) Pub. No.: US 2026/0307833 A1
(43) Pub. Date: Oct. 8, 2026

(54) COMPACT BAG FILLING MACHINE AND METHOD OF USE

(71) Applicant: Sandbags LLC, Henderson, NV (US)

(72) Inventors: Michael David Borden, Las Vegas, NV (US); James A. Skinner, JR., Henderson, NV (US)

(21) Appl. No.: 19/559,754

(22) Filed: Mar. 6, 2026

Related U.S. Application Data
(60) Provisional application No. 63/783,082, filed on Apr. 3, 2025.

(51) Int. Cl. B65B 1/40; B65B 1/12; B65B 37/02; B65B 39/08; B66B 7/06

(52) U.S. Cl. CPC B65B 1/40; B65B 1/12; B65B 37/02; B65B 39/08; B66B 7/06

(57) ABSTRACT

A bag filling machine includes a hopper, a feed assembly, and a controller. The hopper is configured to receive material. The feed assembly includes a fill assembly and an auger configured to transport the material from the hopper to the fill assembly. The controller is configured to control a speed and a runtime of the auger to dispense a predetermined quantity of the material. A method of operating a bag filling machine includes: receiving a material in a hopper; placing a bag around a spout of a fill assembly; sensing placement of the bag with one or more sensors; activating, in response to sensing the placement of the bag, an auger of a feed assembly to transport the material from the hopper to the fill assembly; and controlling, with a controller, a speed and a runtime of the auger to dispense a predetermined quantity of the material into the bag.

### RELATED APPLICATIONS

This application claims priority to and the benefit of the filing date of U.S. Provisional Patent Application No. 63/783,082, entitled “COMPACT BAG FILLING MACHINE AND METHOD OF USE,” filed Apr. 3, 2025, which is incorporated by reference herein in its entirety.

### TECHNICAL FIELD

This disclosure is generally directed to a compact material handling machine for filling bags with a material. In some examples, the apparatus may be used to fill, close, and count sandbags.

### BACKGROUND

Material handling machines (or “bag filling assembly”) can be used to bag various materials, such as sand, gravel, dirt, rocks, minerals, seeds, nuts, grains, foods, etc. Material handling machines may be deployed to facilitate filling of sandbags in areas of flooding. In some uses, material handling machines may be used for filling sandbags in pipeline construction, erosion control, traffic control, crowd control, and military fortification, etc. Material handing machines may be installed in a food production facility to package foods for transport and storage. Material handling machines may be used to fill bags with material, close the filled bags, and count the number of bags that have been filled.

Typically, material handling machines are large stationary structures installed in a production facility or may be configured as a mobile unit such as a specialized truck or large trailer. Due to their size, it can be difficult or impractical to transport material handling machines large distances rapidly for timely deployment and storage during idle periods requires a large storage space.

Accordingly, a need exists for a compact material handling machine that addresses one or more shortcomings of conventional apparatuses.

### SUMMARY

In an aspect of the present disclosure, a bag filling machine may include a hopper configured to receive a material, a feed assembly, and a controller. The feed assembly may include a fill assembly and an auger configured to transport the material from the hopper to the fill assembly. The controller may be configured to control a speed and a runtime of the auger to dispense a predetermined quantity of the material.

In some examples, the fill assembly may include a spout configured to receive the material from the auger, at least one bag clamp configured to retain a bag disposed around the spout, and at least one sensor configured to detect placement of a bag around the spout. The controller may be further configured to, in response to detecting the placement of the bag, actuate the at least one bag clamp and activate the auger to dispense the predetermined quantity of material.

In some examples, a bag filling machine further includes a bagging assembly. The bagging assembly may include a sealing device positioned to receive and seal an open end of the bag and a conveyor configured to transport the bag from the fill assembly to the sealing device. The conveyor and the auger may be powered by one or more electric motors. The at least one bag clamp may be powered pneumatically. The controller may be further configured to control at least one of a speed or a runtime of the conveyor.

In some examples, a bag filling machine further includes a compact frame supporting the hopper, the feed assembly, the bagging assembly, and the controller. The frame may include a base supportable by a plurality of removable legs and a hopper support structure supported by the base. Each leg may include an extendable member configured to adjust a height of the respective leg. A portion of the base may extend outward from the hopper support structure forming a deck configured to support the bagging assembly. The base may have a length of about 4-7 feet and a width of about 3-5 feet. The base may be configured to receive forks of a forklift. The frame may include a compartment deck extending parallel to the base and configured to support the hopper. A compartment may be defined between the base and the compartment deck. The compartment may separate the hopper from the base.

In some examples, the bag filling machine may be self-contained and have an assembled configuration and a disassembled configuration. In the assembled configuration, the plurality of legs may be secured to the base to maintain the base above ground level and the conveyor may be laterally offset with respect to the base. In the disassembled configuration, the plurality of legs may be storable in the compartment and the conveyor may be laterally centered above the base.

In some examples, the controller may include a user interface for receiving a user input to adjust the predetermined quantity within a limited range.

In some examples, the hopper may include an access gate configured to provide a reduced access height to an interior volume of the hopper when the access gate is open.

In an aspect of the present disclosure, a method of assembling a bag filling machine may include lifting a base of a frame of the bag filling machine. The frame may support a hopper configured to receive a material, a feed assembly including a fill assembly and an auger, a bagging assembly, and a controller. The controller may be configured to control a speed and a runtime of the auger to dispense a predetermined quantity of the material. The method may further include securing a plurality of legs to the base of the frame and lowering the base until the plurality of legs contact ground.

In some examples, a method may further include sliding a conveyor of the bagging assembly into an operating position.

In an aspect of the present disclosure, a method of operating a bag filling machine includes receiving a material in a hopper, placing a bag around a spout of a fill assembly, sensing placement of the bag with one or more sensors, activating, in response to sensing the placement of the bag, an auger of a feed assembly to transport the material from the hopper to the fill assembly, and controlling, with a controller, a speed and a runtime of the auger to dispense a predetermined quantity of the material into the bag.

In some examples, a method may further include actuating, in response to sensing the placement of the bag, at least one bag clamp of the fill assembly to secure the bag around the spout. A method may also include transporting the bag from the fill assembly to a sealing device with a conveyor and sealing an open end of the bag with the sealing device.

In some examples, a method further includes receiving a user input at a user interface of a controller and adjusting, in response to the user input, the predetermined quantity within a limited adjustment range by altering the speed or the runtime of the auger. In some examples, the auger is deactivated upon expiration of the runtime.

It is to be understood that both the foregoing general description and the following drawings and detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following. One or more features of any embodiment or aspect may be combinable with one or more features of other embodiment or aspect.

### BRIEF DESCRIPTION OF THE DRAWINGS

The accompanying drawings illustrate implementations of the systems, devices, and methods disclosed herein and together with the description, serve to explain the principles of the present disclosure.

FIG. 1 is a front right upper perspective view of a bag filling machine according to the present disclosure.

FIG. 2 is a rear right upper perspective view of the bag filling machine.

FIG. 3 is a front left lower perspective view of the bag filling machine.

FIG. 4 is a rear left upper perspective view of the bag filling machine with the access gate in an open position.

FIG. 5 is a top view of the bag filling machine.

FIG. 6 is a right side view of the bag filling machine with right compartment door removed.

FIG. 7 is a cross-section view of the bag filling machine.

FIG. 8 is a perspective view of a frame that may be used in the bag filling machine of FIG. 1.

FIG. 9A is a perspective view of a feed assembly that may be used in the bag filling machine of FIG. 1.

FIG. 9B is a front view of a fill assembly of the feed assembly of FIG. 9A.

FIG. 10A is a rear perspective view of a bagging assembly that may be used in the bag filling machine of FIG. 1.

FIG. 10B is a front perspective view of the bagging assembly of FIG. 10A.

FIG. 11 is a front view of a control interface that may be used in the bag filling machine of FIG. 1.

FIG. 12 is a flowchart of a method of operating a bag filling machine.

These Figures will be better understood by reference to the following Detailed Description.

### DETAILED DESCRIPTION

For the purpose of promoting an understanding of the principles of the present disclosure, reference will now be made to the implementations illustrated in the drawings and specific language will be used to describe them. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In addition, this disclosure describes some elements or features in detail with respect to one or more example implementations or figures although those same elements or features may appear in other example implementations or figures without such a high level of detail. It is fully contemplated that the features, components, and/or steps described with respect to one or more example implementations or figures may be combined with the features, components, and/or steps described with respect to other example implementations or figures of the present disclosure. For simplicity, in some instances the same or similar reference numbers are used throughout the drawings to refer to the same or like parts.

The present disclosure is directed to a bag filling machine (or “bag filling assembly”) that is compact and portable. The size and configuration of the bag filling machine facilitates ease of transport and storage. It has an assembled state for operation and a disassembled state for storage and transport which reduces the size even further. The bag filling machine may be converted from the assembled state to the disassembled state in a matter of minutes.

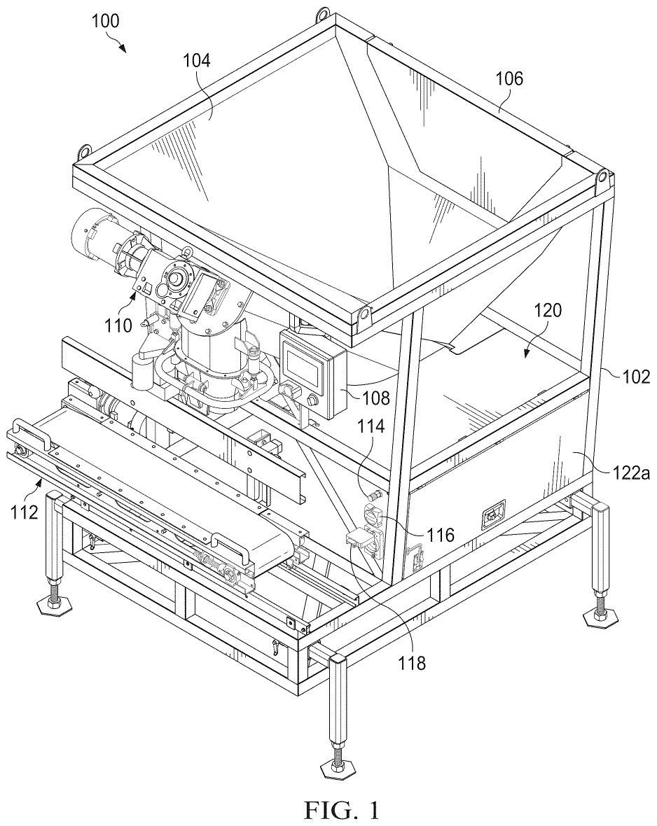

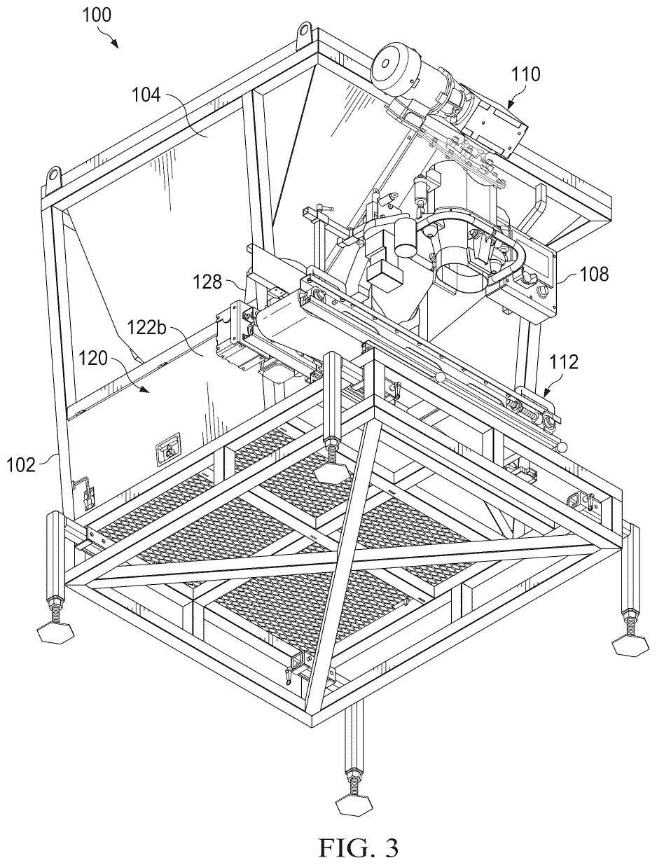

FIGS. 1-7 illustrate various views of a bag filling machine 100 according to the present disclosure. The bag filling machine 100 has a frame 102 supporting a number of components including, but not limited to, a hopper 104, a controller 108, a feed assembly 110 for transporting material from the hopper and filling bags, a bagging assembly 112 for receiving and sealing filled bags, and a compartment 120 housing equipment for provisioning power, all of which are discussed further below.

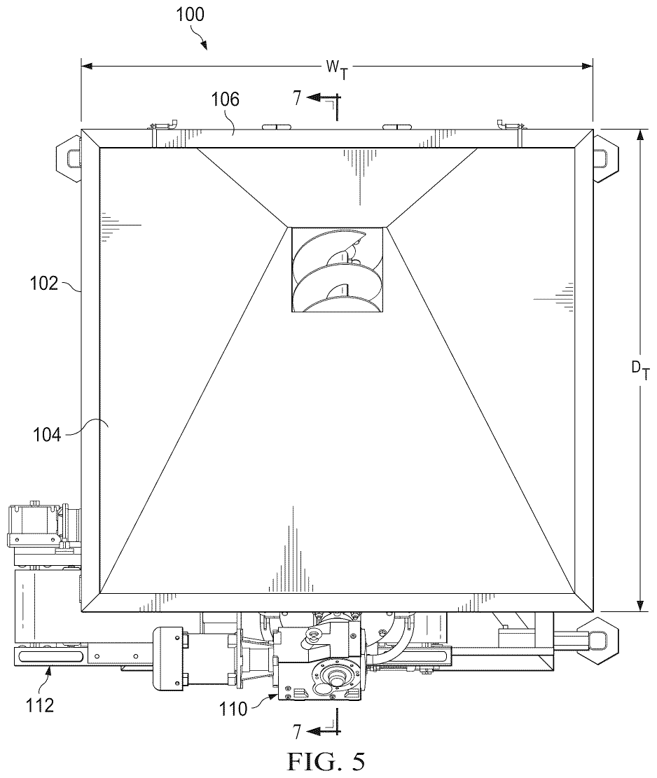

The hopper 104 is configured to receive a material, such as sand or gravel, from its open upper side and store the material until needed for bagging. The illustrated example of hopper 104 has a rectangular upper cross section as seen in FIG. 5 but can have any other shape suitable for receiving material loaded into the top of the hopper 104. In the illustrated embodiment, hopper 104 has a top width W_{T} of about 56 inches and a top depth D_{T} of about 53 inches. It should be noted that these dimensions pertain to the outer dimensions of the portion of the frame 102 enclosing the upper side of the hopper 104. It will be appreciated that these dimensions may vary. For example, in some embodiments, the width W_{T} and/or the depth D_{T} may be in a range of about 30-80 inches. At least one of the width W_{T} or the depth D_{T} may be selected to correspond to a width of a bucket to be used to load material into the hopper, such as a skid steer bucket.

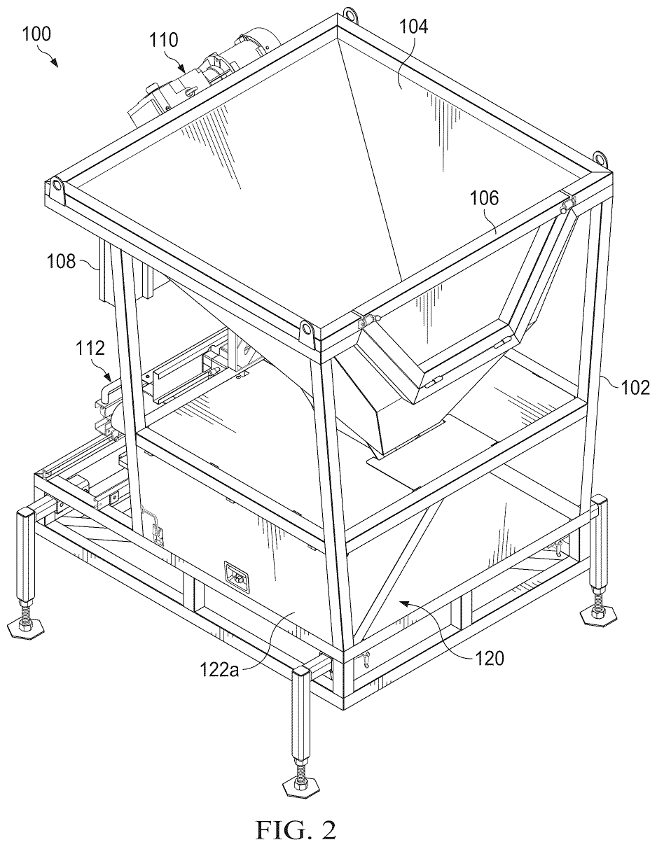

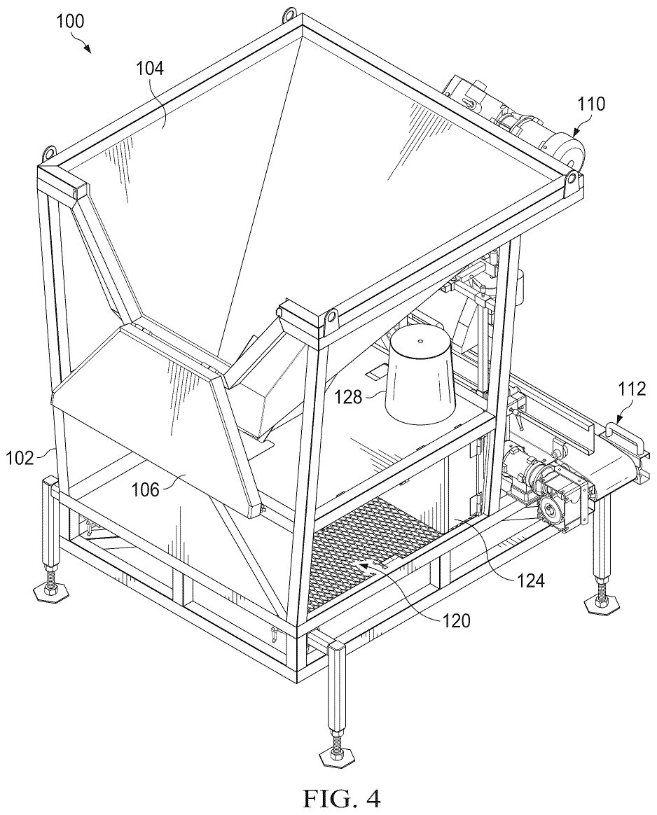

A rear side of the hopper 104 includes an access gate 106 that pivots about one or more hinges from a closed position as shown in FIG. 2 to an open position as shown in FIG. 4. By opening the access gate 106, an access height to an interior volume of the hopper 104 is reduced. The reduced access height allows a user to manually load the hopper 104 with a shovel, for example. By closing the access gate 106, the access height is increased to a level more suitable for loading the hopper 104 with equipment and increases a usable storage volume of the hopper 104. While the access gate 106 is shown at the rear side of the hopper 104, it will be appreciated that the access gate 106 may be positioned at any suitable location around the hopper.

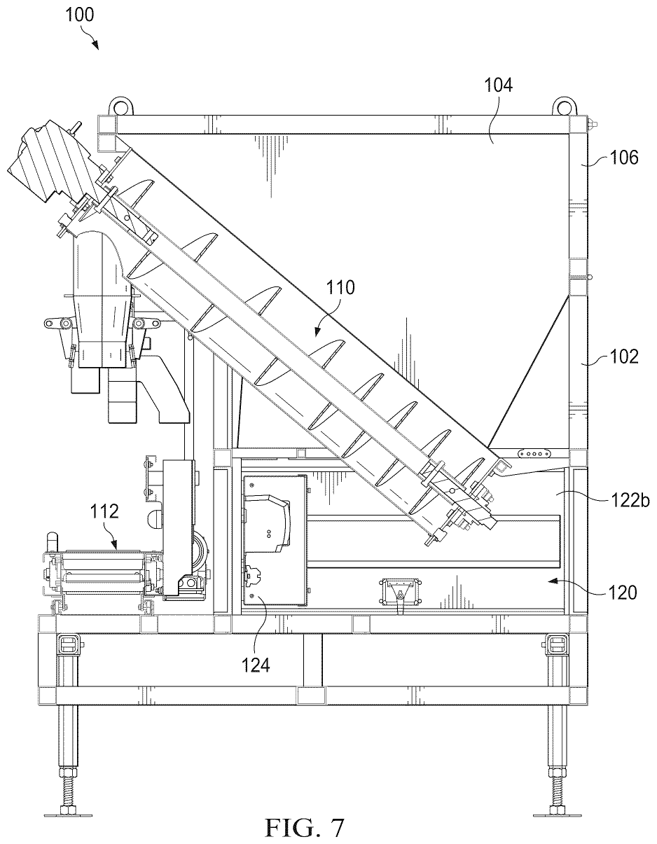

Four walls forming the hopper 104 are angled from the rectangular open upper side to an opening at the bottom. The angled walls direct material towards the opening at the bottom of the hopper. In the illustrated embodiment, the opening is centered along the width W of the hopper but offset longitudinally toward the rear side of the bag filling machine 100. Accordingly, the front and rear walls are angled at different angles than one another and at a different angle than the two side walls. However, in some embodiments the opening may be centered both along the width and depth of the hopper with each of the four walls being angled at generally the same angle. By placing the bottom opening in a rearward position as illustrated, the rear wall requires a steeper angle which is advantageous for placement of the access gate 106 at the rear of the hopper 104. As seen in FIG. 2, for example, the rear wall is formed of two panels, a first panel that is generally vertical with a portion forming an opening that receives the access gate 106 and a second panel below the first panel that angles toward the bottom opening of the hopper 104. As will be appreciated from FIG. 7, placing the bottom opening of the hopper 104 in a rearward position also provides a shallower angle for the front wall of the hopper. This advantageously provides a suitable angle for operation of the feed assembly 110 mounted below the hopper to transport material from the bottom of the hopper upward to a suitable height for filling of the bags.

The hopper 104 may include one or more bang boards (not shown) such as sacrificial wooden planks mounted along the upper opening of the hopper. Bang boards can provide protection for the walls of the hopper to prevent damage from the bucket of loading equipment during loading of material into the hopper 104. The walls of the hopper 104 may also be lined with a protective coating or protective sheets (not shown) such as UHMW (ultra-high molecular weight) polymer sheets. In some examples, the hopper 104 can include a removable cover grate spanning the upper opening that can act as a filter for the material being loaded into the hopper. Clumps of material or extraneous material (e.g., rocks, sticks, garbage, etc.) too large to fit through the openings of the cover grate will be prevented from entering the hopper 104. Cover grates having different sized openings can be used for different materials and applications.

The feed assembly 110 receives material that passes from the hopper 104 into the feed assembly 110 through the bottom opening of the hopper 104. The feed assembly 110 lifts the material received from the hopper 104 and dispenses it into bags, as discussed further below. The bagging assembly 112 is then used to seal the bags, count the number of bags filled, and transport the sealed bags for storage or use.

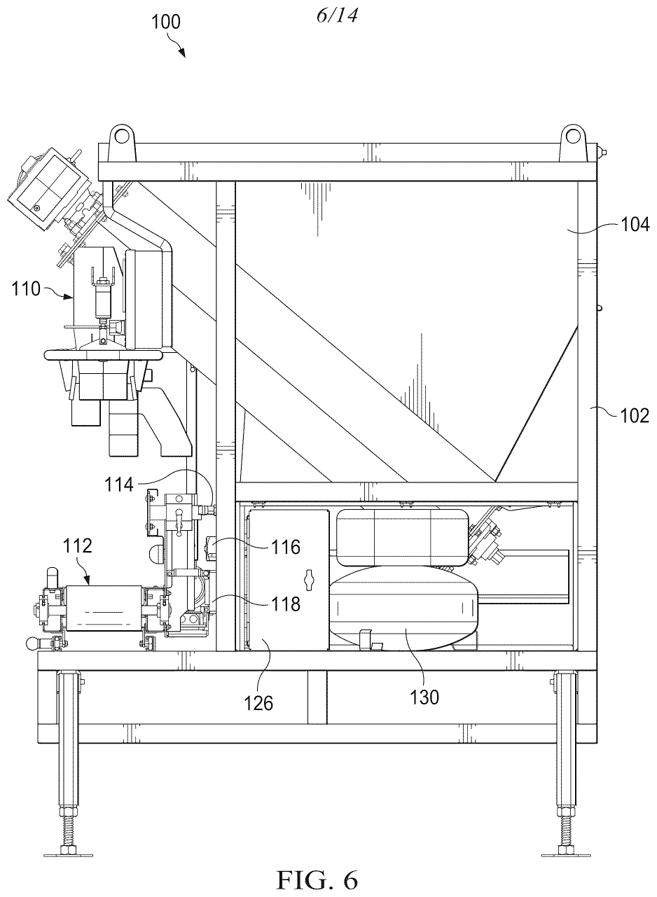

The compartment 120 is positioned below the hopper 104 and houses various power and control devices. The compartment is enclosed but accessible by opening right side door 122a or left side door 122b. As shown in FIG. 6, the compartment houses an air compressor 130 which includes a motor and a storage tank. Although any suitable air compressor may be used, a pancake type air compressor may be particularly suitable to supply a sufficient volume and pressure of air to operate pneumatic devices of the bag filling machine 100 while also fitting within the confines of the compartment 120, providing an on-board pneumatic supply.

The compartment 120 also houses various electrical components such as control module 124 (seen in FIG. 4) and electrical panel 126. The control module 124 and electrical panel 126 collectively house circuit breakers, relays, communications routers, and other electrical components for power distribution, power management, and communication between components of the bag filling machine 100.

A front panel of the compartment 120 houses a hose fitting 114, a master switch 116, and a power port 118 as seen in FIG. 1. The hose fitting 114 is connected to the air compressor 130 within the compartment 120 and provides access to compressed air. A hose may connect to the hose fitting 114 for blowing debris (e.g., material spilled during loading of the hopper or filling of the bags) off the bag filling machine 100. The power port 118 is configured to receive an electrical plug connected to a generator (e.g., 220v) or other power source (not shown) for electrically powering the bag filling machine 100. In some examples, a generator may be incorporated into the bag filling machine 100 (e.g., in the compartment 120) such that the power port 118 is omitted or is disposed inside the compartment. The master switch 116 is wired between the power port 118 or other power supply and the electrical panel 126 and is configured to selectively disrupt the supply of power from the generator to shutdown the bag filling machine 100. The controller 108 is operatively connected to the control module 124 and electrical panel 126 and serves as the primary user interface for operation of the bag filling machine. The controller 108 is discussed in more detail below. It should be appreciated that functions of the controller 108 described herein may be performed entirely by the controller 108 itself or may be distributed between the controller 108 and control module 124 and/or the electrical panel 126.

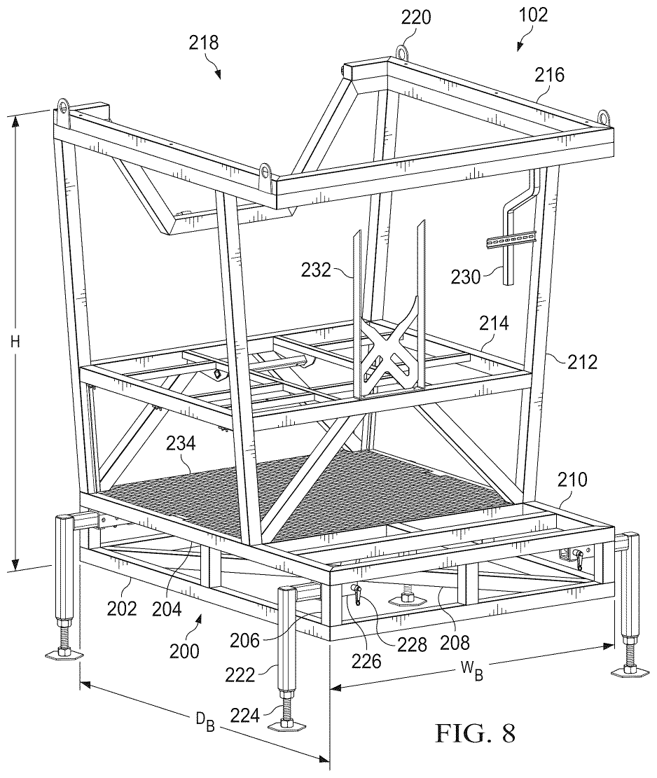

FIG. 8 illustrates the frame 102 with all other components removed. The frame 102 is formed primarily from 2 in.×2 in. tubes, although any other suitable members may be used to construct the frame 102. The tubes may be formed from any suitable materials such as aluminum, steel, etc.

The frame 102 includes a base 200 formed by lower frame member 202 and upper frame member 204 which are interconnected by vertical columns 206. The lower frame member 202 includes a perimeter formed by four tubes and two diagonal braces 208. The upper frame member 204 includes a perimeter formed by four tubes and various lateral and longitudinal connecting tubes. A grate 234 is positioned over the portion of the upper frame member 204 that is within the compartment 120. The grate 234 supports the air compressor 130, hoses, electrical cables, and any other components or accessories to be stored in the compartment 120. The grate 234 has openings that allow debris to fall from the compartment 120 and also allow air to circulate within the compartment for cooling. The vertical columns 206 provide a suitable spacing between the lower and upper frame members 202, 204 to receive forks of a forklift, for example, within the base 200 for lifting the bag filling machine 100. While lifted, four legs 222 can be installed or removed. Each leg 222 is generally L-shape with a portion configured to be received in a respective receiver 226 secured to the base 200. A lock 228 can be actuated to secure each leg within the respective receiver. At a lower end of each leg 222, an extendable member 224 is adjustable to extend further from or retract into the leg 222. The extendable members 224 may be adjusted to level the bag filling machine on uneven ground during setup.

Four posts 212 extend upward from the base 200 and support a compartment deck 214 and top frame member 216. These elements collectively form a scaffold to support the hopper 104. A portion of the base 200 extending forward from the scaffold forms a forward deck 210. The compartment deck 214 includes a perimeter formed by four tubes and various lateral and longitudinal connecting tubes. A feed assembly support 232 extends from the compartment deck 214 and is configured to support the feed assembly 110. The top frame member 216 includes a perimeter formed by four rails. Each rail is formed from two tubes stacked vertically. The rear rail of the top frame member 216 includes a gap 218 in the upper tube of the rail and a recessed region in the lower tube to accommodate the access gate 106. The access gate 106 includes a tubular frame that fits within the gap 218. Four lift connectors 220 are secured to the top frame member 216 to receive hooks for facilitating lifting of the bag filling machine 100 with cables or chains secured to a boom lift, loader bucket, or other suitable equipment. A controller mount 230 extends from the top frame member 216 and is configured for mounting of the controller 108.

The bag filling machine 100 has a height H measured from the bottom of the base 200 to the top of the frame. The height H in the illustrated example is about 60 inches but it will be appreciated that the height H can be any suitable dimension. In some examples, the height H is between about 40-98 inches. The depth D_{B} of the base 200 is about 60 inches in the illustrated example but can be any suitable dimension. In some examples, the depth D_{B} is between about 48-120 inches. The width W_{B} of the base 200 is about 48 inches in the illustrated example but can be any suitable dimension. In some examples, the width W_{B} is between about 40-98 inches. It will be appreciated that the width W_{B} being about 48 inches provides several advantages over prior art material handling machines. Many pickup trucks have a bed with a length of 66-78 inches and a width between the wheel wells of about 50 inches. As such, the base 200 of the illustrated example having a 60 in×48 in footprint is configured to fit within a typical truck bed allowing the bag filling machine 100 to be transported in a standard pickup truck. Additionally, many semi-tractor trailers have an interior width of about 99 inches, allowing two bases 200 to be positioned side by side. The bag filling machine 100 of the illustrated example is flared outward along its sides with a top width W_{T} of 56 inches which would prevent side by side transport of two bag filling machines 100 in a standard enclosed semi-tractor trailer. However, it should be appreciated that in some examples, the sides of the frame 102 may be substantially vertical such that the W_{B}≈W_{T}≈48 inches, thereby allowing bag filling machines of the present disclosure to be transported side by side in a standard tractor trailer.

It should be appreciated that the illustrated frame 102 is only an example and various modifications thereto are within the scope of this disclosure. For example, a greater or lesser number of various components may be provided in the frame 102 such as, but not limited to, legs 222, braces 208, vertical columns 206, tubes, etc. as needed for suitable sizes, shapes, and support of different embodiments.

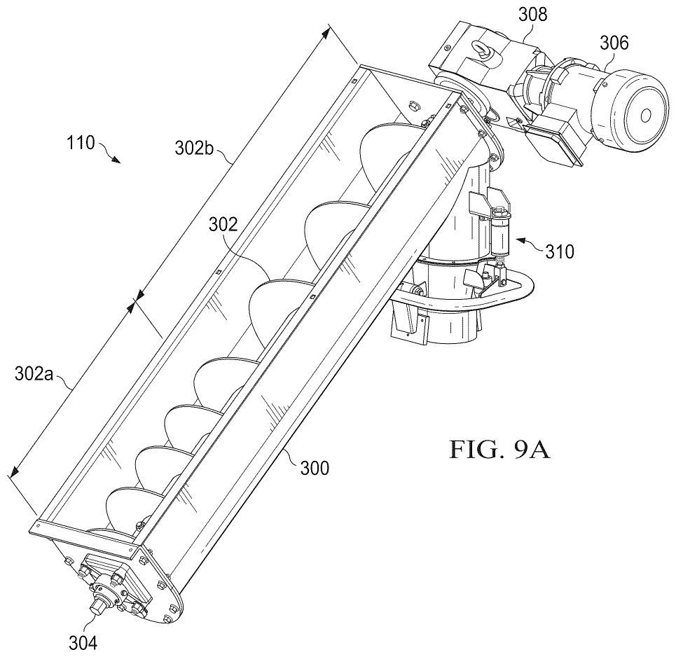

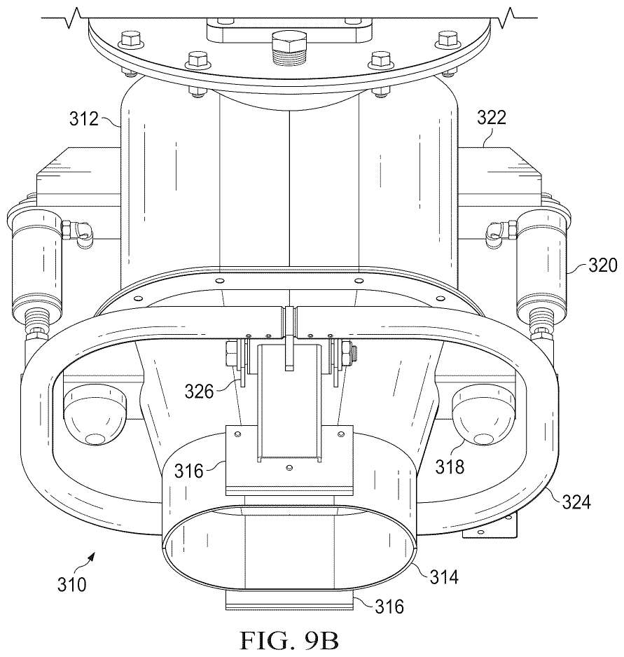

FIG. 9A illustrates an example of a feed assembly 110 of the bag filling machine 100. A trough 300 encloses an auger 302 which is rotated by a motor 306. The motor of the illustrated example is an electric motor 306 operatively connected to the controller 108 and electrical panel 126 for receiving power. The motor 306 is connected to a shaft of the auger 302 through a gearbox 308. As the motor 306 powers the auger 302, the shaft rotates within bearing assemblies 304 disposed at either end of the shaft. Rotation of the auger transports material received at the lower end of the trough 300 from the bottom opening of the hopper 104 up to a fill assembly 310. The controller 108 may meter a quantity (weight or volume) of material that is dispensed into each bag by controlling both the speed of the auger 302 and the amount of time the auger is rotated during each fill cycle. The auger has a varied pitch between adjacent turns of the blade with a smaller pitch length in region 302a and a greater pitch length in region 302b. The smaller pitch in region 302a may improve the ability of the auger 302 to break apart clumps of material which may form, for example, when the water content of the material (e.g., sand) exceeds some percentage. The larger pitch in region 302b improves efficiency of the auger 302, moving material a greater distance with each rotation of the auger.

FIG. 9B shows the fill assembly 310 of the feed assembly 110. A chute 312 is positioned at the upper end of the trough 300 and is in fluid communication therewith to receive material transported by the auger 302. The chute 312 narrows to a spout 314 at its lower end. The spout 314 is sized and shaped to extend into a bag during filling. In the illustrated example, the chute 312 and spout 314 are wide open without any valves or gates disposed therein to meter the flow of material. Rather, the bag filling machine 100 relies on the speed and runtime of the auger 302 to regulate the quantity of material being dispensed. This is advantageous as it prevents blockage and malfunction that may occur in systems that rely on valves to control the amount of material passing through a chute.

A pair of bag clamps 316 are positioned adjacent to the spout 314 and are configured to clamp the bag against the spout during filling. Although illustrated with the bag clamps positioned at a front and a rear side of the spout 314, the bag clamps 316 could be disposed at any suitable position about the spout 314. More or fewer bag clamps 316 could be provided having any suitable size and shape to support the weight of a filled bag without tearing the bag. The bag clamps 316 are activated by actuators 320 which extend between a bracket 322 mounted to the chute 312 and a frame 324 to which the bag clamps 316 are secured. The bag clamps 316 are pivotally mounted to a respective pin hinge 326. Extension of the actuators 320 move the frame 324 downward, thereby pivoting the bag clamps 316 into engagement with the spout 314 with the bag positioned therebetween. Sensors 318 (e.g., proximity detectors) detect when a user's hands have moved into proximity therewith (e.g., within about 15-20 cm) and indicate to the controller 108 that the fill assembly 310 is ready for a fill cycle. In response, the controller 108 activates the actuators 320 to clamp the bag to the spout 314. The actuators 320 may be pneumatic such that the controller 108 operates a valve to supply air pressure to the actuators 320.

After the bag clamps 316 close or simultaneously therewith, the controller 108 may activate the motor 306 to operate the auger 302. When the auger has operated for a predetermined period of time sufficient to fill the bag based on the auger speed, the controller 108 deactivates the motor 306 and retracts the actuators 320 to release the bag clamps 316. The filled bag then falls to the bagging assembly 112.

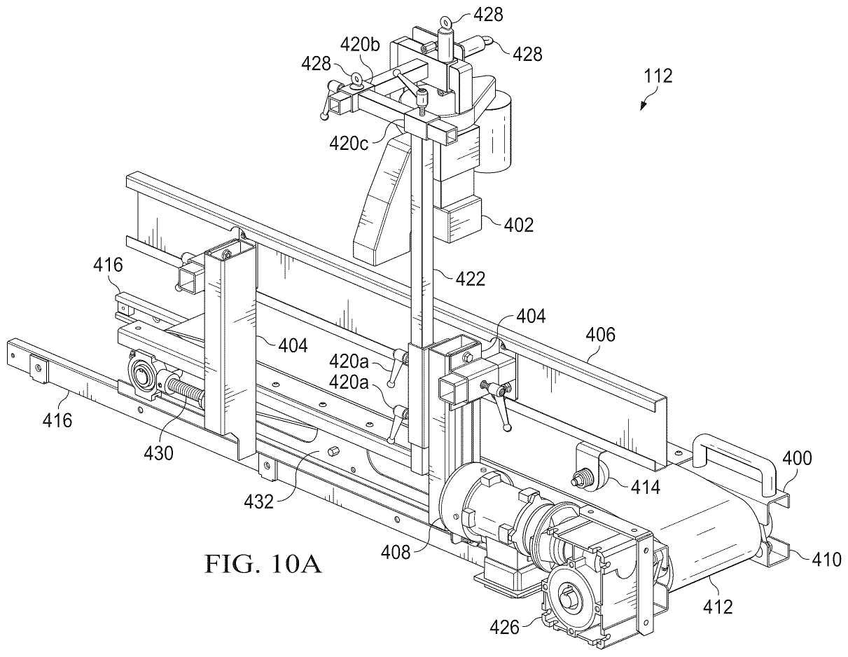

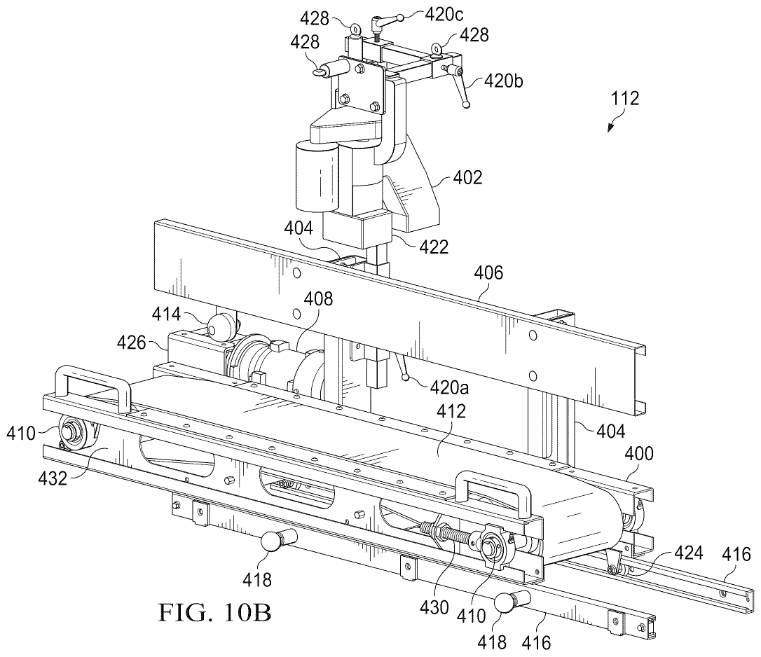

FIGS. 10A-B illustrate a bagging assembly 112 that may be used in the bag filling machine 100. The bagging assembly 112 may be supported on the forward deck 210 of the frame (see FIG. 8) and includes a conveyor 400, a sealing device 402, and counter 414. The conveyor 400 includes a frame 432 supporting rollers 410 about which an endless belt 412 rotates. An electric motor 408 drives one of the rollers 410 through a gearbox 426. A pair of tensioners 430 are adjustable to provide a suitable degree of tension in the belt 412 by moving a roller 410 with respect to the frame 432.

The frame 432 is slidably mounted to a pair of rails 416. Rollers 424 of the frame 432 allow the conveyor 400 to slide with respect to the rails 416. The frame 432 can be secured in a selected position using one or more locking pins 418 extendable through the front rail 416 to block the rollers 424. The rails 416 are centered on and secured to the forward deck 210 of the frame 102 while the conveyor 400, sealing device 402, etc. can be slid laterally with respect to the base 200. In this regard, the bagging assembly 112 can be stored in a central position on the forward deck 210 but deployed into an operating position in which it is cantilevered over a side of the forward deck for optimal positioning of the conveyor 400 and sealing device 402.

The controller 108 is typically configured to continuously run the motor 408 during operation of the bag filling machine 100. In this regard, the belt 412 is in constant motion while bag filling operations are being conducted. However, it will be appreciated that the controller 108 may be configured to activate and deactivate the conveyor 400 with each fill cycle. A guardrail 406 is secured to a plurality of supports 404 which are mounted to the frame 432. The guardrail is adjustable in a forward/rearward direction as needed. The guardrail prevents filled bags from tipping over when transported from the fill assembly 310 across the conveyor 400. As a filled bag passes along the belt 412, an open top end of the bag is guided by the guardrail 406 through a channel 422 in the sealing device 402. In the illustrated example, the sealing device 402 is a sewing machine. The sewing machine may be configured to activate in response to a user stepping on a pedal. Alternatively, a sensor on the sewing machine may detect the presence of a bag and automatically initiate sewing. It should also be appreciated that other sealing devices may be used such as a machine that installs zip ties, bands, straps, clips, staples, etc.

The sealing device 402 is supported by a mount that provides adjustment along three degrees of freedom. Positioners 420 each include a receiver through which a post extends and a lock for securing the post in the receiver. Positioner 420a allows a user to raise or lower the sealing device 402. Positioner 420b allows a user to move the sealing device 402 forward and rearward. Positioner 420c allows a user to move the sealing device laterally. In this regard, the sealing device 402 can be located at an optimal position for receiving a sealing a particular size of bag being used. When the sealing device 402 is a sewing machine, a spool of thread (see spool 128 in FIG. 4) may be mounted to the compartment deck 214 and the thread may be routed through eyelets 428 on the sealing device mount. When the bag filling machine 100 is disassembled, the sealing device 402 with or without the mount may be stored in the compartment 120.

After the belt 412 transports a filled bag through the sealing device 402, the bag passes by an optical counter 414. The optical counter 414 is connected to the controller 108 for maintaining a quantity of bags that have been completed. In some embodiments, the counter 414 may be omitted and the controller 108 may count the number of fill cycles that have been activated.

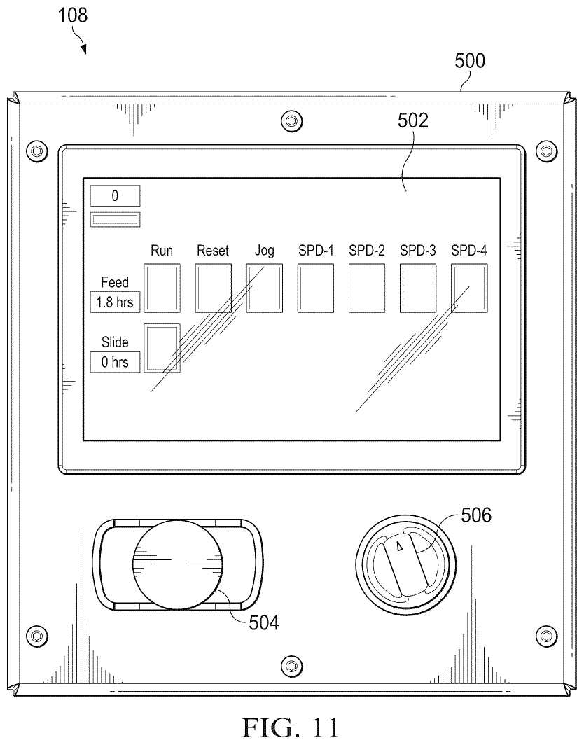

FIG. 11 shows the controller 108. A housing 500 may enclose one or more processors, a memory, a touchscreen, and any other components of the controller 108. The housing 500 may be sealed to prevent dust and debris from fouling these components. A graphical user interface (“GUI”) is displayed on a touchscreen of the controller 108. A kill switch 504 is provided on the controller housing 500 for ease of access by a user. In the event of a malfunction, a user may press the kill switch 504 button to instruct the controller 108 to promptly interrupt any active processes and shutdown the bag filling machine 100. A power switch 506 is provided for selectively turning the controller 108 on/off.

The illustrated GUI 502 provides a plurality of operating options and informational feedback to a user. A total quantity of bags filled, a current runtime, a lifetime runtime, a conveyor speed, an auger speed, an auger runtime, etc. are all examples of information that may be displayed on the GUI. Additionally, virtual buttons provide user selectable operating options including, but not limited to, a run mode, a reset function, a jog mode, and various operating speeds (e.g., auger speed and/or conveyor speed). When utilizing the run mode, the controller 108 will operate the auger 302 in discrete fill cycles. That is, upon detecting a bag at the spout, the controller 108 will activate the bag clamps 316 and activate the auger 302 to operate for a preset runtime at a preset speed. The controller 108 may be calibrated such that the speed and runtime of the auger correspond to a desired volume (or weight) of material to be dispensed during each fill cycle. Upon the expiration of the runtime, the controller 108 will deactivate the auger 302 and deactivate the bag clamps 316. When utilizing the jog mode, the controller 108 will operate the bag clamps in a similar manner but will maintain movement of the auger 302 for a continuous flow of material. The reset function may be activated when a malfunction is observed to reset the controller.

The GUI may provide a user with the option of adjusting the volume (or weight) of material to be dispensed. In some examples, it may be desirable to limit the range of adjustment to prevent underfilling or overfilling of bags. In one example, the user may be provided with an option to adjust the fill quantity by ±10%. While it is preferred to calibrate the controller 108 to dispense a desired quantity of material with each fill cycle, it is advantageous to provide a user with the option to adjust the auger speed and/or runtime within a limited range to account for field conditions. For example, excess water content in the fill material may increase the weight of each filled bag by 10 or more pounds. Similarly, a particularly dry batch of fill material may reduce the weight of each filled bag.

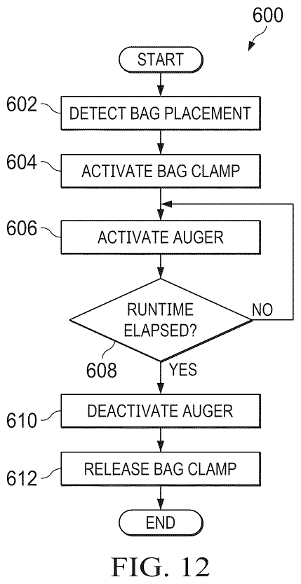

FIG. 12 is a flowchart of a method 600 of operating a bag filling machine. The method 600 corresponds to the ‘run mode’ of the controller 108. It will be appreciated that prior to beginning the method 600, the generator is connected and turned on, the air compressor is charged, and the master switch 116 and controller power switch 506 have been toggled to their ‘on’ position so that all systems are initiated and ready for operation. The motor 408 may also be activated to operate the belt 412.

At process 602, the controller 108 receives a signal from the sensors 318 indicating that a bag has been placed around the spout 314. In response to detecting the placement of a bag, at process 604, the controller 108 initiates a fill cycle activates by the bag clamps 316 by pneumatically actuating the actuators 320. Thereafter or simultaneously, at process 606 the controller 108 activates the auger 302. Specifically, power may be supplied to the motor 306 or an instruction signal may be transmitted to the motor 306 to rotate the auger shaft at a specified speed. The controller 108 maintains a clock to track the current runtime of the auger 302. Based on calibration data indicating a required runtime to dispense a predetermined quantity of material using the specified auger speed, the controller monitors the current runtime at process 608. If the current runtime elapsed has not reached the required runtime, the controller maintains operation of the auger. If the current runtime has reached the required runtime, at process 610 the controller 108 deactivates the auger 302 by disconnecting power supplied to the motor 306 or sending an instruction signal to the motor 306. Thereafter or simultaneously therewith, at process 612 that controller 108 releases the bag clamps 316 to allow the bag to fall onto the bagging assembly 112.

As discussed above, the bag filling machine 100 utilizes electric and pneumatic actuation. The power input to the bag filling machine is 220v and onboard transformers, relays, etc. may be used to distribute 110v and 220v throughout the machine. The sealing device and air compressor operate on a 110v power supply. The air compressor, in turn, supplies compressed air for actuating the bag clamps. In some examples, electric actuation of the bag clamps is contemplated, in which case the air compressor may be omitted.

Although the figures show relative positions of each component, the actual dimension and scale of each component may differ from the illustration and depend on different production specifications.

Additional components and functions may be used in the bag filling machine which are not illustrated or described with specificity to avoid obfuscating the present disclosure. For further description of examples of such additional components and functions see U.S. Pat. App. Pub. No. No. 2015/0151863.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “outer” and “inner,” “upper” and “lower,” “first” and “second,” “internal” and “external,” “above” and “below,” “right” and “left,” and the like are used as words of convenience to provide reference points and are not to be construed as limiting terms.

In addition, the foregoing describes only some embodiments of the invention(s), and alterations, modifications, additions and/or changes can be made thereto without departing from the scope and spirit of the disclosed embodiments, the embodiments being illustrative and not restrictive.

Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

Persons of ordinary skill in the art will appreciate that the implementations encompassed by the present disclosure are not limited to the particular exemplary implementations described above. In that regard, although illustrative implementations have been shown and described, a wide range of modification, change, combination, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A bag filling machine, comprising:
a hopper configured to receive a material;
a feed assembly including:
a fill assembly; and
an auger configured to transport the material from the hopper to the fill assembly; and
a controller configured to control a speed and a runtime of the auger to dispense a predetermined quantity of the material.

2. The bag filling machine of claim 1, wherein the fill assembly comprises:
a spout configured to receive the material from the auger;
at least one bag clamp configured to retain a bag disposed around the spout; and
at least one sensor configured to detect placement of a bag around the spout, wherein the controller is further configured to, in response to detecting the placement of the bag:
actuate the at least one bag clamp; and
activate the auger to dispense the predetermined quantity of material.

3. The bag filling machine of claim 2, further comprising:
a bagging assembly including:
a sealing device positioned to receive and seal an open end of the bag; and
a conveyor configured to transport the bag from the fill assembly to the sealing device.

4. The bag filling machine of claim 3, wherein the conveyor and the auger are powered by one or more electric motors and the at least one bag clamp is powered pneumatically.

5. The bag filling machine of claim 3, wherein the controller is further configured to control at least one of a speed or a runtime of the conveyor.

6. The bag filling machine of claim 3, further comprising:
a compact frame supporting the hopper, the feed assembly, the bagging assembly, and the controller.

7. The bag filling machine of claim 6, wherein the frame comprises:
a base supportable by a plurality of removable legs, each leg including an extendable member configured to adjust a height of the respective leg; and
a hopper support structure supported by the base, wherein a portion of the base extends outward from the hopper support structure forming a deck configured to support the bagging assembly.

8. The bag filling machine of claim 7, wherein the base has a length of about 4-7 feet and a width of about 3-5 feet.

9. The bag filling machine of claim 7, wherein the base is configured to receive forks of a forklift.

10. The bag filling machine of claim 7, wherein the frame further comprises:
a compartment deck extending parallel to the base and configured to support the hopper, wherein a compartment is defined between the base and the compartment deck, the compartment separating the hopper from the base.

11. The bag filling machine of claim 10, wherein the bag filling machine is self-contained and has:
an assembled configuration in which the plurality of legs are secured to the base to maintain the base above ground level and the conveyor is laterally offset with respect to the base; and
a disassembled configuration in which the plurality of legs are storable in the compartment and the conveyor is laterally centered above the base.

12. The bag filling machine of claim 1, wherein the controller comprises a user interface for receiving a user input to adjust the predetermined quantity within a limited range.

13. The bag filling machine of claim 1, wherein the hopper includes an access gate configured to provide a reduced access height to an interior volume of the hopper when the access gate is open.

14. A method of assembling a bag filling machine, comprising:
lifting a base of a frame of the bag filling machine, the frame supporting:
a hopper configured to receive a material;
a feed assembly including a fill assembly and an auger;
a bagging assembly; and
a controller configured to control a speed and a runtime of the auger to dispense a predetermined quantity of the material;
securing a plurality of legs to the base of the frame; and
lowering the base until the plurality of legs contact ground.

15. The method of claim 14, further comprising:
sliding a conveyor of the bagging assembly into an operating position.

16. A method of operating a bag filling machine, comprising:
receiving a material in a hopper;
placing a bag around a spout of a fill assembly;
sensing placement of the bag with one or more sensors;
activating, in response to sensing the placement of the bag, an auger of a feed assembly to transport the material from the hopper to the fill assembly; and
controlling, with a controller, a speed and a runtime of the auger to dispense a predetermined quantity of the material into the bag.

17. The method of claim 16, further comprising:
actuating, in response to sensing the placement of the bag, at least one bag clamp of the fill assembly to secure the bag around the spout.

18. The method of claim 16, further comprising:
transporting the bag from the fill assembly to a sealing device with a conveyor; and
sealing an open end of the bag with the sealing device.

19. The method of claim 16, further comprising:
receiving a user input at a user interface of a controller; and
adjusting, in response to the user input, the predetermined quantity within a limited adjustment range by altering the speed or the runtime of the auger.

20. The method of claim 16, further comprising:
deactivating the auger upon expiration of the runtime.
